(19) United States
(12) Patent Application Publication
(10) Pub. No.: US 2003/0116921 A1
(43) Pub. Date: Jun. 26, 2003

(54) Sealed bearing protection for motors

(75) Inventors: Michael Coles, Kent, OH (US); John H. Porter, Ravenna, OH (US)

Correspondence Address: Ray L. Weber, Renner, Kenner, Greive, Bobak, Taylor & Weber, Fourth Floor, First National Tower, Akron, OH, 44308, US

(73) Assignee: Ametek, Inc.

(21) Appl. No.: 10/352,456

(22) Filed: Jan. 28, 2003

Related U.S. Application Data
(62) Division of application No. 09/883,627, filed on Jun. 18, 2001.

(51) Int. Cl. F16J 15/32

(52) U.S. Cl. 277/572

(57) ABSTRACT

A motor assembly with improved sealing properties includes a motor having a rotatable shaft, a working air fan assembly carried by the shaft, the working air fan assembly moving air therethrough, and a sealed bearing interposed between the working air fan assembly, the sealed bearing having an inner ring rotatable with respect to an outer ring, and a seal carried by one of the rings, the seal frictionally contacting the other of the rings

### TECHNICAL FIELD

The invention herein resides in the art of sealed bearings. In particular, the invention relates to a sealed bearing that prevents water or moisture-laden air from contacting the internal surfaces of the bearing.

### BACKGROUND ART

Presently, some types of cleaning equipment are subjected to water or moisture. In particular, wet/dry vacuum cleaners, such as those known as utility vacs and carpet extractors, operate in an environment in which the debris that is extracted from the surface being cleaned is laden in a mixture of air and water. In order to prevent the moisture-laden air from entering the vacuum generating motor, bypass motors are typically used. As is well known, a bypass motor/fan assembly is one in which the working air, generated by a working air fan, is moved by the motor, but is totally isolated therefrom. The motor itself has a separate motor cooling air fan which draws cooling air over the motor's armature and field. In any event, the working air and the motor cooling air take totally separate paths and do not mix—except possibly in an exhaust area.

Bypass motors typically have a working air fan at an end of a motor/fan shaft, with the fan rotating within a fan shell. One end of the fan shell has an air intake, with the circumference or periphery of the shell having a plurality of spaced-apart exhaust apertures or a tangential exhaust tube. The intake aperture communicates with a vacuum chamber in the cleaning device, while the exhaust ports communicate with the ambient air. The fan shell defines a chamber in which the fan rotates. Once that chamber becomes pressurized, the air therein eventually finds it way to the exhaust ports. Accordingly, the working air fan takes the moisture-laden air from the vacuum chamber and disperses it to the ambient air.

It has been found, especially in applications where moisture is prevalent in the working air, that the moisture migrates into the motor housing and causes failures. In particular, these failures typically occur where the shaft is journaled within a bearing. The moisture contacts the bearing and eventually causes lubricating-grease degradation and loss, rust, and which, in turn, causes the bearing to fail and, in turn, the motor shaft to lock up and burn out the motor.

There have been numerous design modifications attempted to prevent moisture from entering the bearing area. One modification utilizes a grease and/or oil-lubricated synthetic rubber seal disposed on the shaft between the airflow path and the bearing. The lubricant is required as the motor shaft typically rotates at very high speeds. But, the moisture-laden air may have a certain amount of very strong detergent that emulsifies the grease, drying out the lubricating material, and attacking the seal so that moisture eventually migrates along the shaft to the bearing. Moreover, the detergent mixes with the lubricating oil and is then exhausted out the ambient exhaust ports, causing dirt spots or oil spots on the floor upon which the cleaner is used. This is quite upsetting to the user and considered a major product failing of the cleaner. Accordingly, use of synthetic rubber seals as a bearing protection system has been found to be somewhat ineffective.

One attempt at overcoming the aforementioned problem is to employ expanded polytetrafluoroethylene (PTFE) seals disposed on the shaft in place of a rubber seal. This general concept is disclosed in U.S. application Ser. No. 09/716,145 which is entitled “Bearing Protection Assembly For Motors.” This application is assigned to the Assignee of the present invention and is incorporated herein by reference. Although tests have shown the various embodiments disclosed in that application to be effective, the embodiments require added costs for caps to secure the seal and labor for clamping the seal in position.

There have also been attempts in the bearing art to improve the sealing properties of the bearing itself as disclosed in U.S. Pat. Nos. 5,480,235; 5,882,121; and 5,711,616. Generally, the sealing components in these disclosures have a rigid member that has molded thereto a flexible elastic sealing member that attempts to protect the rolling elements contained within the bearing. However, these elements are still susceptible to excessive wear, high temperatures and detergent contained in the moisture-laden air. Eventually these seals are rendered ineffective and break down in much the same manner as the seals positioned into contact with the shaft. Seals disposed on the shaft of the motor assembly or those that are part of the bearing's sealing component are typically made of rubber materials such as Neoprene. Neoprene is the generic name for polymers of chloroprene (CH₂CHCCl═CH₂; 2-chloro-1,3-butadiene). They are available as dry solids and latices, and are vulcanizable to tough products with good resistance to oil, solvents, heat and weathering. Neoprene rubber is a family of elastomers with a property profile that approaches that of natural rubber, but has better resistance to oils, ozone, oxidation, and flame. Neoprene rubber ages better and does not soften upon exposure to heat, although its high-temperature tensile strength may be lower than that of natural rubber. Neoprene can be used to make soft, relatively high-strength compounds. One important difference is that neoprene rubber does not have the low-temperature flexibility of natural rubber, which detracts from its use in low-temperature shock or impact applications. Properties of Neoprene and other common elastomers are shown in Table 1.

TABLE 1

| | Natural | Synthetic | |
|---|---|---|---|
| | rubber (cis- | (poly- | Chloroprene |
| Property | polyisoprene) | isoprene) | (neoprene) |
| PHYSICAL | | | |
| PROPERTIES | | | |
| Specific gravity | 0.93 | 0.93 | 1.25 |
| (ASTM 792) | | | |
| Thermal conductivity | 0.082 | 0.082 | 0.112 |
| Btu/h-ft²-(° F./ft) | | | |
| Coefficient of thermal | 37 | | 34 |
| expansion (cubical), 10⁻⁵ | | | |
| per ° F. | | | |
| Min. recommended | −60 | −60 | −40 |
| service temp. ° F. | | | |
| Max. recommended | 180 | 180 | 240 |
| service temp. ° F. | | | |
| MECHANICAL | | | |
| PROPERTIES | | | |
| Tensile strength, pure | 2500-3500 | 2500-3500 | 3000-4000 |
| gum lb/in² | | | |
| Tensile strength, black, | 3500-4500 | 3500-4500 | 3000-4000 |
| lb/in² | | | |
| Elongation, pure gum, % | 750-850 | | 800-900 |
| Elongation, black, % | 550-650 | 300-700 | 500-600 |
| Hardness (durometer) | A30-90 | A40-80 | A20-95 |
| Tear resistance | excellent | excellent | fair to good |
| Abrasion resistance | excellent | excellent | good |
| CHEMICAL | | | |
| RESISTANCE | | | |
| Sunlight aging | poor | fair | very good |
| Oxidation | good | excellent | excellent |
| Heat aging | good | good | excellent |
| Aliphatic hydrocarbon | poor | poor | good |
| solvent | | | |
| Aromatic hydrocarbon | poor | poor | fair |
| solvent | | | |
| Oxygenated alcohol | good | good | very good |
| solvent | | | |
| Oil, Gasoline | poor | poor | good |
| Animal, vegetable oils | poor to good | | excellent |
| Dilute acids | fair to good | fair to good | excellent |
| Concentrated acids | fair to good | fair to good | good |
| Permeability to gases | low | low | low |
| Water-swell resistance | fair | excellent | fair to excellent |
| Uses | Pneumatic tires | Same as | Wire and cable, |
| | and tubes; | natural | belts, hose, |
| | power-trans- | rubber | extruded |
| | mission belts | | goods, coat- |
| | and conveyor | | ings, molded |
| | belts; gaskets; | | and sheet |
| | mountings; | | goods, adhe- |
| | hose; chemical- | | sives, automo- |
| | tank linings; | | tive gaskets |
| | printing-press | | and seals, pe- |
| | platens; sound | | troleum- and |
| | or shock ab- | | chemical-tank |
| | sorption; seals | | linings |
| | against air, | | |
| | moisture, | | |
| | sound, and dirt | | |

Based upon the foregoing, it is evident that there is a need in the art for a motor assembly that utilizes a bearing with a seal that is long-lasting, effective, and which incorporates improved materials.

### DISCLOSURE OF INVENTION

It is thus an object of the present invention to provide a sealed bearing.

It is another object of the present invention to provide a sealed bearing, wherein the sealed bearing includes an outer and inner ring with rolling elements disposed therebetween, and wherein a seal is carried by one of the rings for contacting the other ring.

It is a further object of the present invention to provide a sealed bearing, as set forth above, wherein one of the inner or outer rings has an annular notch.

It is yet another object of the present invention to provide a sealed bearing, as above, in which the annular notch carries a frame which, in turn, carries the seal.

It is yet another object of the present invention to provide a sealed bearing, as set forth above, in which the frame compresses a portion of the seal to urge a remaining portion into contact with the other ring.

It is still another object of the present invention to provide a sealed bearing, as set forth above, in which the seal is made of a material that is moisture resistant, can withstand high temperatures, is chemically resistant, has superior wear properties, and a low coefficient of friction that does not adversely affect the operation of the associated assembly.

It is still yet another object of the present invention to provide a sealed bearing, as set forth above, wherein the seal is made of a material such as expanded polytetrafluoroethylene.

It is still a further object of the present invention to provide a sealed bearing in use with a motor assembly.

The foregoing and other objects of the present invention, which shall become apparent as the detailed description proceeds, are achieved by a motor assembly with improved sealing properties, comprising a motor having a rotatable shaft, a working air fan assembly carried by said shaft, said working air fan assembly moving air therethrough, and a sealed bearing interposed between said working air fan assembly, said sealed bearing having an inner ring rotatable with respect to an outer ring, and a seal carried by one of said rings, said seal frictionally contacting the other of said rings.

Other aspects of the present invention are attained by a sealed bearing, comprising an outer ring, said outer ring having an inner diameter, an inner ring, said inner ring having an outer diameter, a plurality of rolling elements disposed between said outer ring and said inner ring, and a seal carried by one of said rings, said seal frictionally contacting the other of said rings.

These and other objects of the present invention, as well as the advantages thereof over existing prior art forms, which will become apparent from the description to follow, are accomplished by the improvements hereinafter described and claimed.

### BRIEF DESCRIPTION OF THE DRAWINGS

For a complete understanding of the objects, techniques and structure of the invention, reference should be made to the following detailed description and accompanying drawings, wherein:

FIG. 1 is an elevational view of a motor assembly, in partial cross-section, made in accordance with the present invention; and

FIG. 2 is a cross-sectional elevational view of a sealed bearing made in accordance with the concepts of the present invention.

### BEST MODE FOR CARRYING OUT THE INVENTION

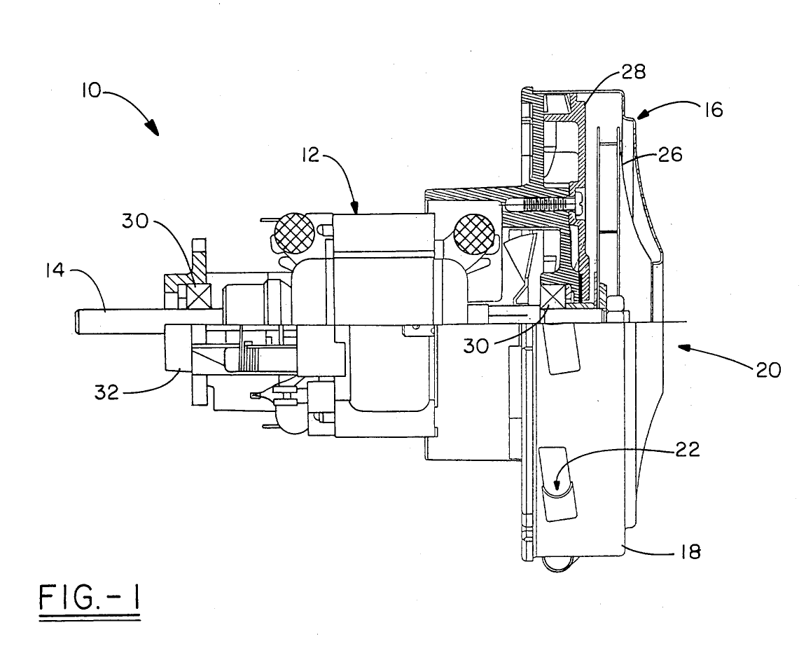

Referring now to the drawings and, in particular, to FIG. 1, it can be seen that a motor assembly is designated generally by the numeral 10. Although a bypass motor assembly is shown, the present invention could be employed with any motor assembly or other device where a sealed bearing is required. In any event, the motor assembly 10 includes a motor 12 which rotates a shaft 14. The motor assembly includes a working air fan assembly 16 which provides a shroud 18. The shroud 18 includes an axial inlet 20 and a plurality of radial outlets 22. A fan 26 is carried and rotated by the shaft 14 within the shroud 18 for the purpose of drawing working air in through the inlet 20. The fan redirects the air radially in such a manner that it is directed through a diffuser 28 which directs the air out through the outlets 22. As discussed previously, the working air may contain moisture or other contaminants. Accordingly, there is a very strong desire to keep this moisture and contaminant-laden air from migrating along the shaft 14 to the motor 12.

To facilitate operation of the motor assembly, a sealed bearing 30 is captured between the diffuser 28 and the shaft 14. Although the diffuser provides some moisture migration protection, the sealed bearing 30 is exposed to elements such as moisture, dust, and other contaminants. As those skilled in the art will appreciate, an end bracket 32 may be provided at an opposite end of the motor assembly 10. Another sealed bearing 30 may be provided between the end bracket 32 and the motor shaft 14.

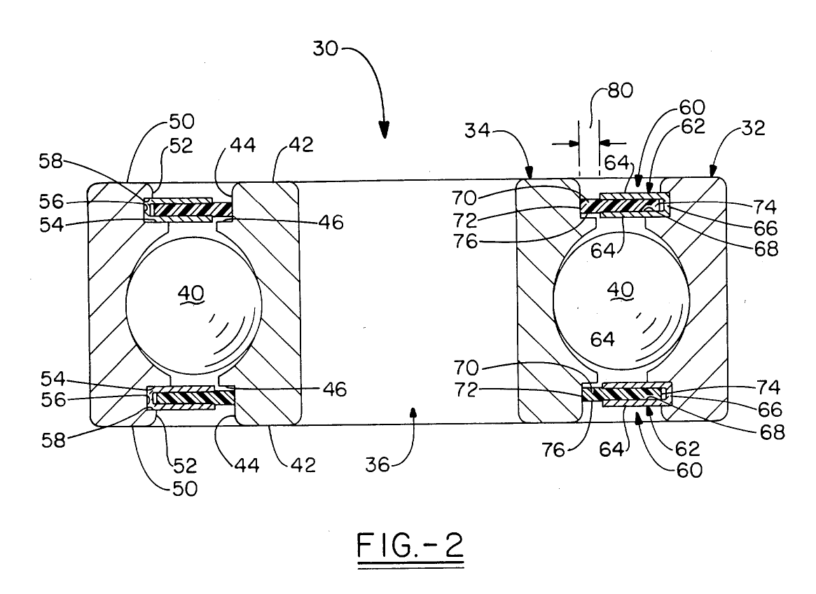

Referring now to FIG. 2, a detailed description of the sealed bearing 30 will be provided. The bearing 30 includes an outer ring 32 that rotatably receives an inner ring 34. The inner ring 34 provides a shaft opening therethrough which is press fit upon the shaft 14 or other rotating member. Depending upon the particular embodiment, the inner ring 34 may have some other internal structural configuration to facilitate rotation of the inner ring 34 with respect to the outer ring 32. Rolling elements 40 are provided between the outer ring 32 and the inner ring 34 and may be a ball, a cylinder, a tapered element, or whatever shape is appropriate for the particular end application.

The inner ring has exposed surfaces 42 from which extends an outer diameter edge 44. Extending annularly outwardly from the edge 44 is a pair of annular lips 46 which face the same direction as the exposed surface 42. The annular lips 46 function to retain the rolling elements 40 within and between the rings 32 and 34.

The outer ring 32 provides exposed surfaces 50 with an inner diameter edge 52 that face the outer diameter edge 44. Extending inwardly from the inner diameter edge 52 is a pair of annular lips 54. It will be appreciated that each annular lip 54 faces in the same direction as the adjacent exposed surface 50 and is aligned with the corresponding annular lip 46. The inner diameter edge 52 includes annular notches 56 that are partially formed by the annular lip 54. Opposed from each annular lip 54 is a rim 58 such that the lip and rim are substantially parallel with one another. Depending upon the particular end application, it will be appreciated that structural features of each annular notch 56 and the rim 58 may be provided as part of the inner ring 34 instead of the outer ring 32. Positioning of the annular notch 56 may also be dependent upon the particular end application in which the bearing 30 is to be used.

A semi-rigid seal frame 60 is inserted into and carried by the annular notches 56. As shown, two seal frames 60 are provided. Of course, if desired, only one seal on one side of the bearing 30 may be provided. The frame, which may also be referred to as a carrier, includes a C-shaped member 62 with opposed, spaced apart, plates 64. The opposed plates 64 are connected at one end by an end plate 66 so as to form a receptacle area 68. A seal ring 70 is received in the receptacle area 68. The seal ring has an inner diameter 72 and an outer diameter 74. The inner diameter 72 includes an edge 76, wherein the edge 76 has a thickness slightly larger than the gap between the plates 64. Accordingly, when the seal ring is received in the seal frame 60, an outer periphery portion of the seal ring 70 is slightly compressed. The portion that is not compressed is referred to as a flange and is designated generally by the numeral 80. The inner diameter 72 of the exposed flange 80 is preferably in uniform frictional contact with the outer edge 44. In other words, the entire inner diameter 72 contacts the inner ring without gaps or openings therebetween. In the event the annular notch is provided by the inner ring, the outer diameter 74 would contact the inner diameter edge 52. Accordingly, the ring which rotates, either the inner ring or the outer ring, is the member that is in frictional contact with the exposed portion of the seal ring 70. It will also be appreciated that the seal frame 60 does not have to be C-shaped. The only structural requirement of the seal frame 60 that it is able to carry the seal ring 70 such that it positions the appropriate edge of the seal ring into frictional contact with the rotating member of the bearing assembly.

Selection of the material used for seal ring 70 has been found to be an important feature of the seal bearing 30. As noted in the background art, rubber materials and the like have been somewhat effective in providing a seal for the rolling elements contained within the bearing. But, it has been determined that improved performance can be obtained by a seal material that has improved properties such as evidenced by a material like expanded polytetrafluoroethylene provided by companies such as W. L. Gore and Associates. Polytetrafluoroethylene (PTFE) is the oldest of the fluoroplastic family, and was first marketed under the Du Pont trade name “Teflon.” PTFE is characterized by its extreme inertness to chemicals, very high thermal stability, low coefficient of friction, and ability to resist adhesion to almost any material. Although PTFE is generally accepted as an important engineering material due to its properties, it has an inherent creeping property under load, especially at high temperatures. Expanded polytetrafluoroethylene (ePTFE) is made by stretching the PTFE as it is extruded. Shaped articles of ePTFE are useful when the following properties are required: chemical resistance, corrosion resistance, low frictional properties, non-stickiness, electrical insulating properties, heat resistance, compression creep resistance, compression resistance, impact strength, dimensional stability, gas barrier properties and tensile strength. The tensile strength for a sheet of ePTFE is on the order of 14,500 psi in the x and y directions.

In comparison to Neoprene, ePTFE has superior resistance to water and other chemicals, can operate over a wider range of temperatures, and has an extremely low coefficient of friction. Typical properties of ePTFE are shown in Table 2.

TABLE 2

| Property | ePTFE |
|---|---|
| Compressibility/Recovery, ASTM F-36 | 40-70/17% |
| Sealability, 30 psig (2-bar-air) ASTM F-37B | 0.10 ml/hr |
| Sealability, 10 psig (0.7-bar-liquid) ASTM F-37B | 0.004 ml/hr |
| Creep Relaxation, 22 hrs @ 73° F., ASTM F-38 | 18% |
| Creep Relaxation, 22 hrs @ 212° F., ASTM F-38 | 32% |
| Creep Relaxation, @ 200° F., ATRS | 30% |
| Creep Relaxation, @ 400° F., ATRS | 53% |
| Maximum Surface Stress ROTT | 25,000 psi |
| Internal Operating Pressure, @ 600° F., HOBT2 | 750 psi |
| Operating Temperature Range, ° F. | −450 to +600 |
| Chemical resistance | Resistant to all media |
| | in the 0-14 pH range, |
| | except molten alkali |
| | metals. |

It is also known that expanded polytetrafluoroethylene is hydrophobic and does not degrade from excessive exposure to moisture and/or detergent-type materials. Moreover, the material can withstand frictional heat generated by contact with a rotating shaft and it has also been demonstrated to have superior wear properties. Accordingly, by providing a seal that can withstand the rigors of bearing operation, the seal precludes entry of contaminants into the rolling element area. As such, those rolling elements are protected and last longer. Accordingly, the bearings have a longer life and, since the bearings are one of the first elements to fail in a motor assembly, the motor assembly has a longer life. Another advantage of the present invention is that alternative ways for modifying the bearings and other systems for precluding moisture from entering the bearing area are avoided, thus reducing the overall cost of the construction and assembly of a motor assembly. Although the sealed bearing disclosed herein is used in the context of a bypass motor assembly, it will be appreciated that the sealed bearing could be used in any application where a bearing is used.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

What is claimed is:

1. A motor assembly with improved sealing properties, comprising:
a motor having a rotatable shaft;
a working air fan assembly carried by said shaft, said working air fan assembly moving air therethrough; and
a sealed bearing interposed between said working air fan assembly, said sealed bearing having an inner ring rotatable with respect to an outer ring, and a seal carried by one of said rings, said seal frictionally contacting the other of said rings.

2. The motor assembly according to claim 1, wherein said sealed bearing further comprises:
a frame carried by one of said rings, said frame holding said seal, said frame compressing a portion of said seal so as to urge a remaining portion of said seal into contact with the other said ring.

3. The motor assembly according to claim 2, wherein said outer ring has a notch that securably receives said frame.

4. The motor assembly according to claim 1, wherein said seal is made of expanded polytetrafluoroethylene.

5. The motor assembly according to claim 1, wherein said seal withstands temperatures of about between −450° F. to about 600° F.

6. The motor assembly according to claim 1, wherein said seal is chemically resistant to media in the 0-14 pH range except molten alkali materials.

7. A sealed bearing, comprising:
an outer ring, said outer ring having an inner diameter;
an inner ring, said inner ring having an outer diameter;
a plurality of rolling elements disposed between said outer ring and said inner ring; and
a seal carried by one of said rings, said seal frictionally contacting the other of said rings.

8. The bearing according to claim 10, wherein said inner diameter has at least one annular notch from which outwardly extends an annular lip, said annular notch and said annular lip securably receiving and supporting said seal.

9. The bearing according to claim 11, further comprising:
a seal frame that carries said seal, said seal frame securably received in said annular notch.

10. The bearing according to claim 12, wherein said seal frame compresses at least a portion of said seal and urges an uncompressed portion of said seal into contact with the other of said rings.

11. The bearing according to claim 10, wherein said seal is made of expanded polytetrafluoroethylene.

12. The seal according to claim 7, wherein said seal withstands temperatures of about between −450° F. to about 600° F.

13. The seal according to claim 7, wherein said seal is chemically resistant to media in the 0-14 pH range except molten alkali metals.
